(19) United States
(12) Patent Application Publication
(10) Pub. No.: US 2026/0263198 A1
(43) Pub. Date: Sep. 10, 2026

(54) METHOD FOR STRINGING A DENTAL FLOSS DEVICE AND DENTAL FLOSS DEVICE

(71) Applicant: welumo UG (haftungsbeschränkt), Birkenfeld (DE)

(72) Inventor: Christopher KONRAD, Stuttgart (DE)

(73) Assignee: welumo UG (haftungsbeschränkt), Birkenfeld (DE)

(21) Appl. No.: 19/554,218

(22) Filed: Mar. 2, 2026

(30) Foreign Application Priority Data
Mar. 5, 2025 (DE) 10 2025 108 256.1

(51) Int. Cl. A61C 15/04

(52) U.S. Cl. CPC A61C 15/046; A61C 15/043

(57) ABSTRACT

A method for stringing a dental floss device with dental floss, including the steps of: providing a dental floss dispenserfilled with dental floss; providing a dental floss sticksuitable for guiding dental floss; guiding the dental floss from the dental floss dispenser around the dental floss stick; clamping and/or tensioning the dental floss on the dental floss stick; and severing the dental floss such that the dental floss with the dental floss stick is usable separately from the dental floss dispenser. The dental floss stick is releasably connected to the dental floss dispenser prior to guiding the dental floss, in particular releasably connected free of additional securing elements, in particular via a plug-in connection, and for use of the dental floss stick with the clamped dental floss (20), the dental floss stick is detached from the dental floss dispenser, in particular after clamping and, in particular, prior to severing.

### CROSS-REFERENCE TO RELATED APPLICATION

This application claims priority under 35 USC §119 to German Patent Application No. 10 2025 108 256.1, filed on Mar. 5, 2025, the entire disclosure of which is incorporated herein by reference.

### Technical Field of the Invention

The invention relates to a method for stringing a dental floss device, and to a dental floss device for cleaning interdental spaces.

### Brief Description of the Related Art

Devices and methods for cleaning teeth, in particular interdental spaces, such as dental floss, interdental brushes and the like are well known in the art. However, dental floss, for example, is quite difficult for a user to handle. For better handling of dental floss for cleaning interdental spaces, dental floss applicators, for example, are known.

DE 20 2006 007 120 U1, for example, discloses an applicator for dental floss comprising: a housing formed of two cover shells, the housing having a through-opening and a recessed chamber; a dental floss rod having a rear side attached to a front side of the housing, wherein a front side is configured to hold a length of dental floss in a tensioned state; and a floss groove for guiding a dental floss over the front side of the dental floss rod. Furthermore, the device comprises a pick-up wheel pivotally mounted in the through-opening of the housing and fixed to a shaft to secure one end of a dental floss and to receive the secured dental floss; a floss reel rotatably supported on a first shaft, the floss reel having a gear wheel fixedly provided on one side thereof, wherein the floss reel winds a dental floss having an end extending through the floss groove across the front of the dental floss rod and being connected to the pick-up wheel. Also disclosed is a spring frame mounted in the housing, the spring frame having a pressing portion extending out of the housing to be pressed by a user, a stopper portion suspended in the housing, the stopper portion having an abutment surface cooperating with the gear wheel, a receiving chamber, and a spring member mounted in the receiving chamber and retained between a side wall of the receiving chamber and a part of the housing. The device further includes a rotatable knob mounted in the recessed chamber of the housing, the rotatable knob having a shaft inserted through a through-opening of the spring frame and connected to the shaft to rotate the pick-up wheel and a series of inclined teeth extending around an inner circumference thereof; and a resilient pawl mounted on the rotatable knob in the recessed chamber of the housing, the resilient pawl having a plurality of tooth blocks cooperating with the inclined teeth of the rotatable knob. When the rotatable knob is pressed, the pick-up wheel and the shaft are rotated, the resilient pawl is forced to deflect, and the stopper portion of the spring frame is disengaged from the gear wheel to allow the gear wheel to rotate on the second shaft during the deflection of the resilient pawl, whereby the pick-up wheel is rotated synchronously with the rotatable knob to take up the dental floss from the reel and rewind the used length of dental floss.

EP 0 379 504 B1 discloses a dental floss applicator comprising: a fork having two elongate prongs extending from an elongate handle; a container on the handle for holding a supply of dental floss; and a dispenser on the applicator for drawing a continuous strand of dental floss under tension from the container and for guiding the dental floss from the container across a space between end portions of the prongs, such that the dental floss is fed without interruption and held under tension across said space for cleaning teeth. The dispenser includes a rotatable spool around which the dental floss is wound, such that rotation of the spool unwinds the dental floss from the container and guides it along one prong and across said space between the prongs. Furthermore, the dispenser includes a stub shaft on a side opposite the spool, which is rotatable together with the spool such that dental floss extends across said space and along the other prong and is then wound around the stub shaft to tension the dental floss portion extending across said space as a result of the rotation of the spool and the stub shaft. The tension is generated via a differential tensioning means utilizing a larger diameter of the stub shaft compared to that of the spool, such that more dental floss is wound around the stub shaft than around the spool due to the simultaneous rotation of the stub shaft and the spool, thereby generating the differential tension. The applicator further comprises a clamp on the handle between the spool and the container, which is adjustably movable toward a stop device over which the dental floss is passed before being wound onto the spool, and which is configured to exert pressure on the dental floss by moving the clamp toward the stop device, thereby applying a controlled amount of tension to the dental floss before it is wound onto the spool.

DE 44 40 617 A1 discloses a dental floss stick for cleaning deposits and food residues from interdental spaces, wherein a carrier has a recess at a front end thereof , the carrier being surrounded by a groove on a flat side and having a split at a rear end which follows the course of the groove and is configured with a V-shaped exit. A hole passes transversely through the resulting jaws, through which a screw extends that is held by a knurled nut, wherein the screw head is shaped to prevent rotation during tightening of the knurled nut. This knurled nut includes a spacer and a collar with a larger diameter, gripping grooves, and optionally a screwdriver groove.

The known devices are often designed to be very small for trouble-free use in the limited oral cavity, such that stringing them with dental floss often exceeds the manual dexterity of the user. Larger devices, which are better suited for being strung with dental floss, are more difficult to handle within the confined space of the mouth.

### SUMMARY OF THE INVENTION

It is an object of the present invention to provide a method, a reusable dental floss stick , and a dental floss dispenser compatible therewith, which allow for greater user comfort, reliable cleaning of the interdental area, and compatibility with all conventional dental flosses and dental tapes. In particular, the stringing with dental floss is improved.

These and further objects are achieved by a method and a dental floss device as described in the independent claims. Advantageous further embodiments of the invention are specified in the dependent claims and the following description.

The invention teaches that a method for stringing a dental floss device, in particular for stringing a dental floss stick of a dental floss device with dental floss, and more particularly a dental floss device as described herein, comprises various steps. These steps are set forth below.

Specifically, the method includes the step of providing a dental floss dispenser, particularly a dental floss dispenser filled with dental floss. The dental floss dispenser may have any shape, preferably an ergonomic shape that allows for single-handed gripping, such as a pistol grip. The dental floss dispenser stores the dental floss, preferably internally, but in some embodiments also at least partially externally. In particular, the dental floss is stored in the dental floss dispenser before the dental floss dispenser is provided. The dental floss may also be supplied separately from the dental floss dispenser. Preferably, the dental floss is stored within the dental floss dispenser.

Specifically, the method includes the step of providing a dental floss stick suitable for guiding dental floss. The dental floss stick may be provided simultaneously with, before, or after the provision of the dental floss dispenser. In embodiments, the dental floss stick is stored in and/or on the dental floss dispenser. In particular, the dental floss stick is arranged within the dental floss dispenser. In this instance, providing the dental floss stick comprises removing the dental floss stick from the dental floss dispenser. This is preceded by opening the dental floss dispenser. Closing the dental floss dispenser occurs subsequent to the removal. Subsequent to the closing, the dental floss stick is attached to or inserted into the dental floss dispenser. In particular, the attachment is performed by engaging the connecting member of the dental floss stick with the corresponding connecting member of the dental floss dispenser. The connecting member of the dental floss dispenser is preferably located on the top side and/or a side of the dental floss dispenser. The two connecting members are designed to be complementary and/or compatible. A single connecting member may be provided in each case. In embodiments, a plurality of connecting members may be provided instead of a single connecting member.

Specifically, the method includes the step of guiding the dental floss, in particular out of the dental floss dispenser, around the dental floss stick, and more particularly at least partially around the dental floss stick. The dental floss stored in the dental floss dispenser is guided around the dental floss stick. Preferably, the dental floss is guided around the dental floss stick, in particular circumferentially around the dental floss stick, such that it spans a cut-out or a recess of the dental floss stick. The spanning portion of the dental floss is intended for cleaning interdental spaces. The guiding is performed, in particular, along a circumferential groove of the dental floss stick. In embodiments, the groove is formed circumferentially without deflections—between a start of the groove and an end of the groove—over an arc of at least 60°, preferably at least 45°, and most preferably at least 30°. Preferably, the dental floss is guided along a clamping device. The guiding is carried out such that the dental floss spans the recess so that the dental floss stick is in a strung state. The spanning dental floss is preferably placed under mechanical tension.

Specifically, the method includes the step of clamping and/or tensioning the dental floss on the dental floss stick. The clamping and/or tensioning step occurs subsequent to guiding the dental floss. The dental floss guided around the dental floss stick is clamped after the dental floss stick has been strung in this manner. Clamping and/or tensioning is preferably performed against the dental floss stick, in particular exclusively against the dental floss stick. For this purpose, the clamping and/or tensioning is carried out by means of a suitable clamping device provided or to be provided on the dental floss stick. For example, clamping and/or tensioning is performed by tightening a screw against the dental floss stick or another part. For clamping and/or tensioning, the dental floss is guided along the clamping device. In this process, the dental floss is partially arranged in the region of the clamping device and can be clamped and/or tensioned by means of the clamping device. In particular, the clamping and/or tensioning can be performed several times, specifically during use. Preferably, the clamping and/or tensioning is performed once before use. Clamping and/or tensioning is preferably coupled with a rotary movement, in particular of the clamping device. Tension is applied to the dental floss via the rotary movement. The clamping device thus enables tensioning of the dental floss simultaneously with the clamping. The dental floss is thus clamped exclusively via the clamping device on the side of the dental floss stick facing away from the dental floss dispenser. In embodiments, the dental floss may additionally or alternatively be clamped via the clamping device on the side of the dental floss stick facing the dental floss dispenser.

Specifically, the method includes the step of severing the dental floss so that the dental floss can be used with the dental floss stick separately from the dental floss dispenser. The dental floss is pulled from the dental floss dispenser and guided around the dental floss stick so that the dental floss stick is strung. To prevent the dental floss from coming loose from the dental floss stick, it is clamped and/or tensioned on the dental floss stick. After clamping and/or tensioning, the dental floss spanning the dental floss stick is separated from the remaining dental floss located in and/or on the dental floss dispenser. This separation can be carried out in any manner, for example by tearing or cutting. Preferably, the separation is performed with a cutting unit provided on the dental floss stick or on the dental floss dispenser. Preferably, the cutting unit is provided on the dental floss dispenser. The severing is preferably carried out after detaching the dental floss stick, in particular the strung dental floss stick, from the dental floss dispenser, but in other embodiments, it can also be carried out beforehand.

Specifically, the method includes the step of releasably connecting the dental floss stick to the dental floss dispenser, in particular by releasably connecting it free of securing elements, before guiding the dental floss, and specifically before guiding the dental floss around the dental floss stick, i.e., stringing. Preferably, one end of the dental floss stick is inserted into and/or onto the dental floss dispenser via suitable connecting members, in particular via further suitable connecting members. The connection is established as a plug-in connection, a click-fit connection, and/or in a similar releasable manner. Additional securing of the plug-in connection is preferably not provided. In embodiments, securing of the plug-in connection via securing elements, in particular quick-release securing elements, is provided. Preferably, no additional securing is provided, so that the connection is realized solely by plugging it on and/or plugging it in. The plug-in connection is preferably maintained for the duration of the stringing, and thus for guiding the dental floss around the dental floss stick, as well as for clamping and/or tensioning.

Specifically, the method includes the step that, for use of the dental floss stick with the clamped dental floss, the dental floss stick is detached from the dental floss dispenser subsequent to clamping and/or tensioning, in particular prior to severing. To release, the dental floss stick is lifted off or removed from the dental floss dispenser, whereby the connecting members interacting in the manner of a plug-in connection are moved apart. The cancellation of an additional securing mechanism is eliminated. The strung dental floss stick can be used separately from the dental floss dispenser, in particular prior to severing the dental floss. Detachment thus comprises lifting or removing the dental floss stick from the dental floss dispenser without the need to release securing elements. In embodiments, an initial force is to be applied which, for example, overcomes a click-fit connection of a click fastener. Preferably, the release exclusively comprises moving the dental floss stick and the dental floss dispenser apart.

In embodiments, it is provided that the release is performed subsequent to clamping and/or tensioning, in particular prior to severing. As soon as the dental floss stick is moved relatively away from the dental floss dispenser, the dental floss spanning the dental floss stick is severed from the dental floss remaining in or on the dental floss dispenser. The movement away occurs in the opposite direction to the connecting of the dental floss stick to the dental floss dispenser, which is preferably performed free of securing elements. When connecting the dental floss stick to the dental floss dispenser, the dental floss stick is moved relatively toward the dental floss dispenser. The relative movement occurs such that the connecting members can be brought into or out of engagement. In this process, first connecting members of the dental floss dispenser engage with the second connecting members of the dental floss stick to form a plug-in connection, or the engagement is released to disconnect the plug-in connection.

In embodiments, it is provided that the clamping and/or tensioning is performed via a clamping device provided on the dental floss stick, wherein the clamping device is released prior to guiding and is clamped subsequent to guiding. Prior to stringing the dental floss stick with the dental floss—more precisely, prior to guiding the dental floss around the dental floss stick—the clamping device is released. This is performed, for example, by a rotary movement, such as a screwing rotary movement, in particular of the clamping device or a part of the clamping device. In the released state, the clamping device forms a gap with the dental floss stick. The dental floss is guided around the dental floss stick and through the gap. After the dental floss has passed through the gap, the dental floss is clamped. This is performed by a corresponding counter-movement of the clamping device, such as a counter-rotary movement. Clamping and/or tensioning is performed with a clamping force. The clamping force may be selected depending on the type and nature of the dental floss. Preferably, the clamping force is selected such that the dental floss is held securely during use and the tension is at least substantially maintained. In embodiments, the clamping and/or tensioning is performed multiple times. If it becomes apparent during use that the clamping and/or tension of the dental floss is decreasing, re-clamping and/or re-tensioning may be performed, optionally with a higher clamping force, wherein releasing the clamp is optional and preferably omitted. After use of the strung dental floss stick, the clamping and/or tension is released and the dental floss is removed from the dental floss stick and/or disposed of. In this manner, a reusable dental floss stick is provided.

In embodiments, it is provided that for clamping and/or tensioning, the dental floss is guided toward and away from the dental floss dispenser along the same side of the clamping device and is then clamped and/or tensioned, preferably on the same side of the clamping device. For stringing the dental floss stick or guiding the dental floss around the dental floss stick, the dental floss is first moved away from the dispenser, more specifically out thereof, then moved around the dental floss stick, and finally moved away from the dental floss stick again. Moving away preferably occurs in a direction in which the cutting unit is located. The cutting unit is preferably located on the dental floss dispenser. Thus, for stringing, the dental floss is first moved away from the dental floss dispenser and then moved back toward the dental floss dispenser. In the process, the dental floss passes the clamping device—more specifically a gap formed by the dental floss stick and the clamping device—both when being guided away from the dental floss dispenser and when being guided toward the dental floss dispenser. Since the dental floss stick is circumferentially surrounded by the dental floss, it is generally possible to guide the dental floss past different sides of the clamping device. It is preferably provided that when the dental floss is guided around the dental floss stick, the dental floss is guided on the same side of the clamping device, in particular also of the dental floss stick, but always between the clamping device and the dental floss stick, specifically through the gap.

The invention also teaches that a dental floss device, in particular a dental floss device for cleaning interdental spaces, is provided with means for carrying out the method described herein. The means or the dental floss device specifically comprise the features set forth below.

In embodiments, a dental floss stick is provided. The dental floss stick is configured such that dental floss can be guided and/or is guided around or over the dental floss stick. In this process, the dental floss runs around at least one end of the dental floss stick, which is intended for use in an oral cavity.

In particular, in a strung state, the dental floss spans a recess of the dental floss stick. The recess is provided at one end of the dental floss stick. Preferably, a single recess is provided. In embodiments, a plurality of recesses may be provided. The recess may have any shape. Preferably, the recess has an approximately semi-circular or U-shaped cross-section in a plan view. The recess is laterally delimited by preferably two arms or extensions of the dental floss stick. The arms protrude from the remainder of the dental floss stick in a fork-like manner. The arms may be arranged in the same plane as the remainder of the dental floss stick. In embodiments, the arms protrude transversely from the plane of the remainder of the dental floss stick. The protrusion preferably follows a curved path. At the respective outermost ends of the arms, which are remote from the remainder of the dental floss stick, the arms project from the dental floss stick, in particular from the plane of the dental floss stick, at an angle ranging from approximately 45° to 120°, further preferably from 75° to 100°, and most preferably from 80° to 90°. The plane of the recess is preferably arranged transversely to the plane of the remainder of the dental floss stick. The plane of the recess is defined by the arms of the dental floss stick. The plane of the dental floss stick is defined by the remainder of the dental floss stick.

In particular, the dental floss device comprises a dental floss dispenser. The dental floss dispenser may be any dental floss dispenser. Preferably, the dental floss dispenser is a dental floss dispenser having an interior space, in which the dental floss can be stored and/or is stored and/or in which the dental floss stick can be stored and/or is stored. The dental floss dispenser is configured to accommodate the dental floss and/or the dental floss stick. For this purpose, the dental floss dispenser has at least one interior space. The interior space may be divided into a plurality of parts, resulting in a plurality of interior regions. The interior regions may be at least partially connected to one another. In embodiments, the plurality of interior spaces are separated from one another, for example by corresponding walls in the interior space. To securely accommodate the dental floss stick and/or the dental floss, corresponding holding devices are provided in the interior space. The holding devices may be fixedly connected to the dental floss dispenser. In embodiments, the holding devices are designed to be variable, so that one or more dental flosses, in particular in various arrangements, and/or one or more dental floss sticks, in particular of various shapes, can be held securely or are held in the interior space. In embodiments, an encapsulation or a cage is provided or can be provided in the interior space, which enables hygienic accommodation of the dental floss. The cage or encapsulation at least partially surrounds the dental floss, in particular at least partially circumferentially, so that the dental floss is at least partially shielded from external disruptive influences. The encapsulation or cage may be provided in the interior space in a stationary and/or movable manner.

In particular, the dental floss stick is releasably connectable and/or connected to the dental floss dispenser via a plug-in connection, a click fastener, and/or the like, specifically releasable free of securing elements, preferably by plugging it on and/or plugging it in. For a plug-in connection, the dental floss dispenser comprises corresponding first connecting members and the dental floss stick comprises corresponding complementary second connecting members. The connecting members are configured for plug-in interaction. For this purpose, the connecting members are configured to be releasably connectable by relative movement toward and into one another. In embodiments, the connecting members comprise extensions, moldings, protrusions, ribs, undercuts, and the like, and correspondingly on the other side, recesses, grooves, bores, openings, through-holes, receptacles, undercuts, and the like. The connecting members are configured in particular for a form-fit and/or force-fit plug-in connection. Accordingly, the plug-in connecting members are complementary in terms of the cross-sections of their interlocking sections. For example, the first connecting member is configured as a cylindrical depression. Complementary thereto, the second connecting member is configured as a complementary cylindrical extension that can be inserted into the cylindrical depression. Other embodiments, such as one resilient extension or two resilient extensions for a click-fit connection, in particular with end lugs for snapping into complementary openings, are provided or foreseeable. In particular, the cross-sections of the interlocking sections are rotationally asymmetrical. In embodiments, the cross-sections of the interlocking sections are rotationally symmetrical. The cross-sections may have any shape such as circular, oval, polygonal, or even irregular cross-sections. The connection is thus realized in a form-fit manner without the need for additional securing elements, such as force-fit and/or material-fit securing elements. Integrated securing elements, such as those in a click fastener, are not to be understood as additional securing elements.

In embodiments, it is provided that the dental floss dispenser is configured with a housing base body. The housing base body comprises a base unit. A wall projects circumferentially and transversely from the base unit. The wall may be continuous, uninterrupted, or interrupted. Preferably, the wall is continuous. The base unit and the wall projecting therefrom form the pot-shaped housing base body of the dental floss dispenser. The base unit and the wall thus define and/or surround at least a portion of the interior space of the dental floss dispenser.

In particular, the dental floss dispenser comprises a cover device removable from the housing base body for opening and/or closing the interior space defined and/or formed by the housing base body and the cover device. The cover device is configured to be complementary to the housing base body, such that the cover device forms a plug-in connection with the housing base body by being placed on and/or plugged onto the housing base body. In embodiments, the cover device comprises a cover unit from which a wall protrudes circumferentially and transversely. The wall may be interrupted or continuous. In particular, the wall is continuous, i.e., uninterrupted.

For a flush connection between the cover device and the housing base body, one wall—preferably the wall of the housing base body—comprises a shoulder, such that a portion of the wall extending from the shoulder has a smaller dimension, for example a smaller outer diameter, compared to the remaining wall in the direction of the cooperating contact surface with the complementary wall. In this manner, the complementary wall can be placed onto the recessed wall and abuts against the shoulder. The remaining, non-recessed wall has essentially the same outer dimension as the complementary wall. The recessed wall has essentially the same outer dimension as the inner dimension of the complementary wall.

In embodiments, it is provided that the cover device has, on the outer side facing away from the housing base body and/or laterally, a first connecting member which is complementary to a second connecting member of the dental floss stick provided for releasable interaction, in particular releasable interaction free of securing elements, with the first connecting member. The first connecting member is configured as an opening or depression into which at least the second connecting member can be inserted. Preferably, the first connecting member has a groove adjoining the opening or widening the opening, in which at least a portion of the dental floss stick, in particular a portion of the dental floss stick adjoining the second connecting member, can be received. In this manner, a rotationally symmetrical or a rotationally asymmetrical plug-in connection can be realized. In the inserted state, the plug-in connection preferably has only one degree of freedom, and more preferably no degree of freedom.

In embodiments, it is provided that the dental floss stick has the second connecting member at its end arranged remote from the recess. Preferably, the second connecting member is arranged at an end of the dental floss stick that is remote from the recess which is spanned in the strung state. The second connecting member is complementary to the first connecting member and is configured to interact with the first connecting member, in particular to interact free of securing elements. The connecting members for the plug-in connection are configured to be complementary such that the plug-in connection realized by the connecting members has only one degree of freedom, and preferably no degree of freedom. The plug-in connection can thus be released simply by moving along a single direction of movement, preferably by an essentially linear relative movement of the connecting members to each other. Preferably, an initial force can be applied to release an integrated holding or securing function, for example, when the connecting members are configured as a click-fit fastener. By forming a plug-in connection with a maximum of one degree of freedom, no further securing elements, such as screws, adhesives, etc., are required to handle the dental floss device without causing unintentional detachment of the dental floss stick from the dental floss dispenser.

In embodiments, it is provided that the cover device has a through-opening and/or a cutting unit on the outer side facing away from the housing base body in order to guide dental floss out of the interior space of the dental floss dispenser or to sever it from the remaining dental floss remaining in the interior space. The dental floss is arranged in the interior space of the dental floss dispenser. For stringing, the dental floss stick is arranged on the outside of the dental floss dispenser. To string the dental floss stick, the dental floss is passed through a through-opening of the dental floss dispenser. Preferably, the through-opening is provided in the upper side of the cover device. A guiding and/or holding aid may be provided at or in the through-opening, by means of which the dental floss can be guided or held. For example, the dental floss can be guided out of the interior space through the guiding aid and held in the pulled-out state via the holding aid. During severing, this prevents the dental floss from unintentionally returning completely into the interior space. The dental floss guided out of the interior space is guided around the dental floss stick. In this process, the guiding occurs from the through-opening around the connected dental floss stick to at least the clamping device. By means of the cutting unit, the dental floss required for stringing is separable from the remaining dental floss that remains in or on the dental floss dispenser. The cutting unit may be any cutting unit with which separation can be realized. Preferably, the cutting unit is configured as a unit provided with a cutting edge, for example, as a corresponding metal sheet. The cutting unit is preferably arranged in a corresponding receptacle on the cover device, in particular on the outside of the cover unit. Preferably, the through-opening and the cutting unit are arranged on opposite sides of the area of the cover device divided by the inserted dental floss stick.

In embodiments, a clamping device is provided on the dental floss stick. The clamping device prevents the dental floss guided around the dental floss stick from loosening or detaching. The strung dental floss stick is thus held in a strung state, in particular with a set tension of the dental floss. The clamping device is releasably connected to the dental floss stick. To guide the dental floss around the dental floss stick, the clamping device is released so that a gap is formed between the dental floss stick and the clamping device. The dental floss is guided through this gap for stringing the dental floss stick. As soon as the dental floss is guided through the gap, the clamping device is brought into a clamping and/or tensioning state. In this process, the dental floss is clamped and/or tensioned against the dental floss stick. In this manner, clamping of the dental floss is realized or can be realized even when the dental floss stick is in a state detached from the dental floss dispenser. For example, the clamping device is configured as a screw connection. The screw connection preferably comprises a screw, a handle, and a nut. The handle has a through-opening through which the screw can be inserted with its screw shank. To allow the screw to pass through the dental floss stick, the latter likewise has a through-opening. After the screw has passed through the through-opening of the dental floss stick, the screw shank of the screw protrudes beyond the dental floss stick. The nut is arranged on the protruding end of the screw shank. The screw has a screw head. To accommodate the screw head in the handle, the handle has a corresponding receiving opening configured to be complementary to the screw head. Preferably, the receiving opening and the complementary screw head are configured such that the screw head cannot rotate within the receiving opening and is thus arranged in a rotationally fixed manner. For clamping and/or tensioning, the handle is rotated. In this process, the screw head, which is held rotationally fixed in the receiving opening, is rotated as well. The screw shank rotates together with the screw head and is screwed into the nut upon rotation. This brings the handle closer to the dental floss stick. An initial gap present between the handle and the dental floss stick is thereby reduced. The dental floss located in the gap is clamped and/or tensioned between the handle and the dental floss stick as the gap is reduced. To release, the handle is rotated in the opposite direction. The gap increases, and the clamping/tensioning of the dental floss within the gap is released. Other types of clamping/tensioning may be realized by a clamping device of a correspondingly different design. Other clamping devices, with which the dental floss tension can be realized or is realizable even when the dental floss stick is detached from the dental floss dispenser, may be provided or are foreseeable.

In embodiments, it is provided that the dental floss dispenser is configured as a type of pistol grip which has two different, in particular two different but contiguous, sections for ergonomic gripping. The pistol grip is to be understood such that it forms a grip for the elongated dental floss stick—longitudinally or transversely—relative to its main direction of extension. Similar to a pistol, the handle protrudes from the main direction of extension and enables ergonomic gripping. The handle protrudes in such a way that, when gripped by a user, the dental floss stick projects as an extension of the arm of the gripping user, either transversely or longitudinally thereto. The dental floss dispenser, configured in the manner of a pistol grip, has two different sections for ergonomic gripping. In a plan view, the two sections form an approximately figure-eight-shaped or keyhole-shaped cross-section. The dental floss dispenser thus has approximately two partially overlapping hollow cylinders with a circular or oblong cross-section that merge into one another. The diameters of the respective hollow cylinders are preferably different, in particular the outer diameters.

The dental floss stick is attached or attachable to the dental floss dispenser such that one of the arms is arranged closer to the dental floss dispenser than the other arm. The arms thus project transversely, in particular at an angle of at least 45°, from a plane defined by the surface or top side of the cover device. The cover device has a surface and/or a top side on the side facing away from the housing base body. At least the cutting unit and/or the through-opening is formed thereon, at least within a tolerance range ranging from approximately 0.1 mm to 5 mm, more preferably from 0.2 mm to 4 mm, and most preferably from 0.3 mm to 3.5 mm above and/or below—in particular parallel above and/or below—the plane of the surface or top side. The arms of the dental floss stick protrude transversely from the plane, in particular at an angle of at least 45°, more preferably at least 60°, and most preferably at least 75°. An imaginary longitudinal axis extending from the dental floss stick—i.e., excluding the area of the recess—preferably lies in extension of the plane, wherein the longitudinal axis projects transversely to the plane at an angle preferably ranging from 70° to 110°, more preferably from 80° to 100°, and most preferably from 85° to 95°. Accordingly, not only is one arm of the dental floss stick arranged closer to the dental floss dispenser when connected, but the end of one arm is also arranged further away from the surface/top side or the plane spanned thereby, except in the case of an extension of the dental floss stick deviating from 90° (excluding the area of the recess and the arms). In the clamping area, the dental floss stick preferably has two guides for the dental floss, each in the form of a depression. The clamping device is configured to clamp the dental floss against the dental floss stick, in particular exclusively against the dental floss stick, such that a dental floss held between the clamping device and the dental floss stick remains clamped by the clamping device and the dental floss stick even when the dental floss stick is detached from the dental floss dispenser. The dental floss dispenser has a longitudinal axis extending from the base unit of the housing base body toward the cover device. This axis preferably extends transversely, in particular orthogonally, from the base unit and/or the cover device, specifically from a plane spanned by the cover device and/or the base unit. The cover device and/or base unit are preferably configured as flat surfaces, but may also be configured as curved surfaces in embodiments. The imaginary longitudinal axis of the dental floss stick forms an angle with the longitudinal axis of the housing base body as described above, wherein the angle is preferably between 70° and 110°, more preferably between 75° and 100°, and most preferably between 80° and 95°. The guide for the dental floss is arranged laterally on the dental floss stick such that the guide is deflection-free—i.e., without deflections at an angle ranging from 10° to 170°, more preferably from 15° to 160°, and most preferably from 20° to 150°—viewed transversely to the path defined by the guide, i.e., in the direction in which the recess is spanned by the dental floss. At no point do extensions of the guide form an angle of less than or equal to 45°, preferably less than 35°, more preferably less than 25°, and most preferably less than 15° relative to the plane spanned by the arms.

In embodiments, it is additionally or alternatively provided that, in the connected state, the surface of the dental floss stick and the surface of the dental floss dispenser lie within a region which is bounded by a first plane and a second plane, both parallel to a reference plane. The first plane is located at a maximum distance of 5 mm, preferably a maximum of 3 mm, from the reference plane, and the second plane is located at a maximum distance of 5 mm, preferably a maximum of 3 mm, from the reference plane on the opposite side thereof. The top side of the dental floss dispenser spans the reference plane. Offset from this reference plane, a further offset plane is imaginary located on each side of the reference plane, which are at a distance or within a range from each other. Within this region defined by the two further offset planes lie the reference plane spanned by the top side of the dental floss dispenser, the top side of the dental floss stick, and the top side of the dental floss dispenser.

Further advantageous embodiments of the invention are specified in the subclaims or result from the description of exemplary embodiments of the invention. All features and/or advantages emerging from the claims or the description, including structural details, spatial arrangements, and method steps, may be essential to the invention, both individually and in a wide variety of combinations.

The invention is explained in more detail below with reference to an exemplary embodiment shown in the drawings. Uniform reference numerals are used for identical or similar components or features. Features or components of different embodiments can be combined to obtain further embodiments. All features and/or advantages emerging from the claims, the description, or the drawings, including structural details, spatial arrangements, and method steps, may be essential to the invention both individually and in various combinations.

### BRIEF DESCRIPTION OF THE DRAWINGS

The drawings show:

FIG. 1 a schematic, perspective exploded view of an embodiment of a dental floss device;

FIG. 2 a schematic front view of an embodiment of the dental floss device including a section line A-A;

FIG. 3 a schematic side sectional view of an embodiment of a dental floss stick along the section line A-A;

FIG. 4 a schematic perspective view of the embodiment according to FIG. 3 in an assembled, unstrung state;

FIG. 5 a schematic view of the embodiment according to FIG. 4 during a stringing process;

FIG. 6 a schematic perspective view of the use of the embodiment in a strung, detached state;

FIG. 7 a schematic view of a portion of the embodiment according to FIG. 6 in another perspective view;

FIG. 8 a schematic view of the embodiment according to FIG. 7 in another perspective;

FIG. 9 a schematic view of the embodiment according to FIG. 5 with a different grip position;

FIGS. 10A-10G schematic perspective views of a process for assembling a dental floss stick and cleaning interdental spaces with another embodiment of a dental floss device;

FIGS. 11 A-11C a schematic representation of a connection or disconnection process of an embodiment of a dental floss stick from an embodiment of a dental floss dispenser in various views;

FIG. 12 a schematic perspective view of a dental floss stick detached from a dental floss dispenser;

FIG. 13 a schematic perspective view of a plane spanned by the top side of the dental floss dispenser while holding an embodiment of a dental floss device;

FIG. 14 a schematic side view of an embodiment of a dental floss device with a plane spanned by the top side; and

FIG. 15 a schematic side view of an embodiment of a dental floss device with a longitudinal axis extending orthogonally to the main direction of extension and passing through the housing base body and the cover device.

### DETAILED DESCRIPTION OF THE EMBODIMENTS

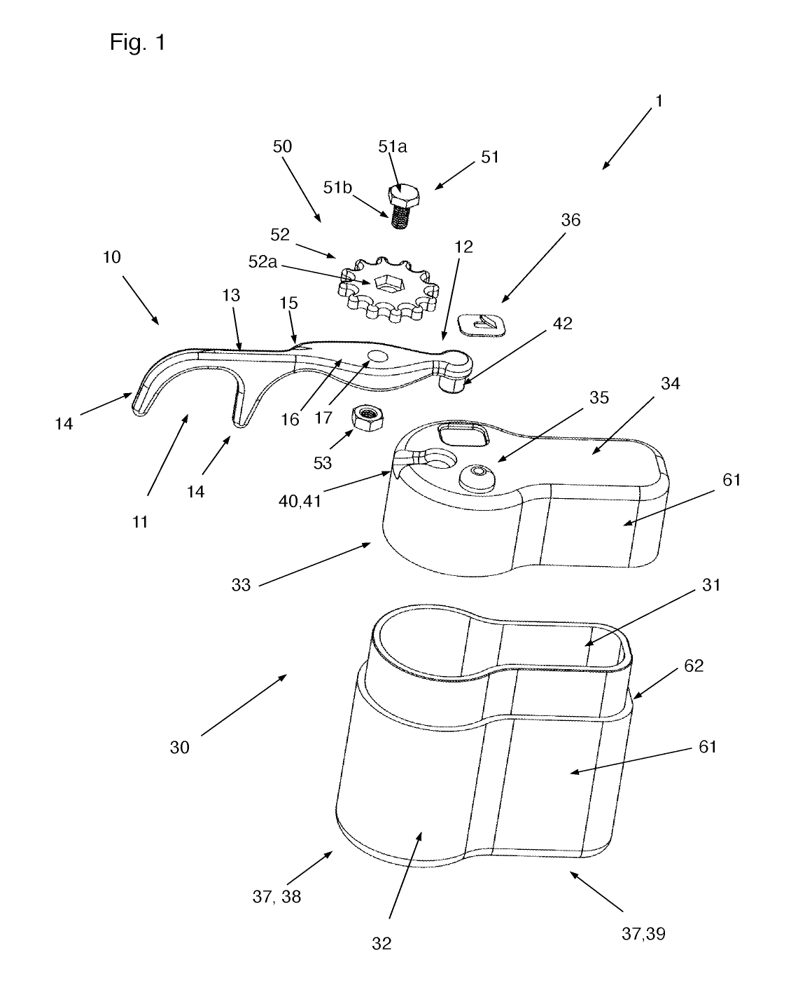

FIGS. 1 to 15 show various embodiments of a dental floss device 1 in different views and degrees of detail. The illustrated dental floss device 1 comprises an elongated dental floss stick 10. The dental floss stick 10 is configured for stringing with dental floss 20. In the strung state, the dental floss 20 is guided circumferentially around the dental floss stick 10 and spans a recess 11. For stringing, the dental floss stick 10 is connected to a dental floss dispenser 30 via a plug-in connection 40 in a pluggable and releasable manner, in particular free of securing elements. The dental floss dispenser 30 is configured to accommodate the dental floss 20 and the dental floss stick 10 in an interior space 31 thereof. The interior space 31 is defined or formed by a housing base body 32 and a complementary cover device 33. For a releasable, pluggable connection with the dental floss dispenser 30, the dental floss stick 10 has second connecting members 42, which are configured to be complementary to first connecting members 41 of the dental floss dispenser 30. A cutting unit 36 is provided for cutting the dental floss 20 when the dental floss stick 10 is in the strung state. To guide the dental floss 20 out of the interior space 31, the cover device 33 has a through-opening 35. To clamp and/or tension the dental floss 20 on the dental floss stick 10, a clamping device 50 is provided. The clamping device 50 comprises a screw 51 having a screw head 51a and a screw shank 51b. Furthermore, the clamping device 50 comprises a handle 52 having a receiving opening 52a for the screw head 51a. In addition, the clamping device 50 comprises a nut 53 which interacts with the screw shank 51b. In particular, the nut 53 has an internal thread which interacts with an external thread of the screw shank 51b. FIG. 1 shows a structure of the illustrated embodiment.

The dental floss stick 10 is configured as an elongated dental floss stick 10 having a first end 12 at which the second connecting members 42 are arranged. In the illustrated embodiment, the second connecting member 42 is configured as a circular cylindrical protrusion 42 which projects from an underside of the dental floss stick 10 transversely to the main direction of extension of the dental floss stick 10. Circumferentially, the dental floss stick 10 has a groove-like depression 13 configured to guide the dental floss 20 along the dental floss stick 10. The depression 13 extends over the two arms 14 which delimit or define the recess 11. In a side view, the recess 11 is approximately semi-circular, and the arms 14 are correspondingly configured to be approximately U-shaped or semi-circularly ring-shaped. The arms 14 span a plane of the recess 11 which is transverse to the plane defined by the remainder of the dental floss stick 10. To deflect the dental floss 20 in the strung state, the dental floss stick 10 has at least one further groove 15. In a further embodiment, the dental floss stick 10 has two grooves 15. Preferably, the further groove 15 is additionally or alternatively arranged in a mirrored manner on the other side of the dental floss stick relative to an imaginary longitudinal axis extending from the remainder of the dental floss stick 10 (i.e., excluding the area of the recess 11 or the arms 14). In this manner, a design for both left-handed and right-handed users can be realized. The dental floss stick 10 has a body widening 16 in the plane defined by the remainder of the dental floss stick 10 (excluding the area of the arms 14). This body widening 16 is configured to interact with the clamping device 50. A through-opening 17 is provided in the widening 16, which serves for the insertion of the screw shank 51b. The handle 52 is arranged on the body widening 16 such that the receiving opening 52a of the handle 52 is aligned with the through-opening 17. The nut 53 is arranged on the underside of the dental floss stick 10, more specifically on the widening 16. The nut 53 is arranged such that the through-opening of the nut 53 is aligned with the through-opening 17 of the widening 16. At the end 12, the dental floss stick 10 has the second connecting member 42 in the form of a circular cylindrical protrusion. This is configured for the plug-in connection 40 with corresponding, in particular complementary, first connecting members 41 of the dental floss dispenser 30. The first connecting member 41 or members 41 comprise, in addition to the first connecting member 41 corresponding to (and in particular complementary to) the second connecting member 42—here in the form of a circular cylindrical recess—a further recess configured to be corresponding to (and in particular complementary to) the section of the dental floss stick 10 adjacent to the second connecting member 42. In a plug-in connection, the first and second connecting members 41 and 42 are brought into engagement. In this process, the section of the dental floss stick 10 adjacent to the second connecting member 42 engages in the further recess. This ensures that the dental floss stick 10 is prevented from twisting relative to the dental floss dispenser 30.

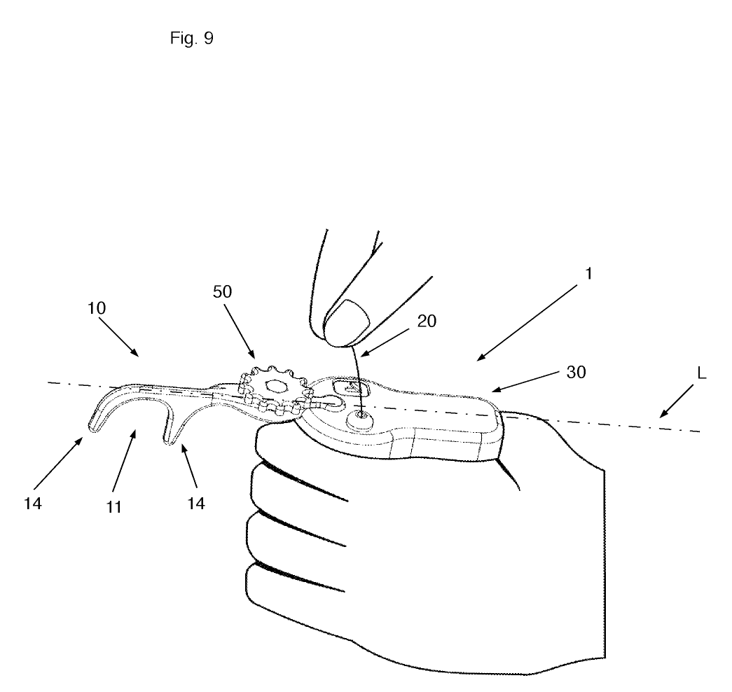

The dental floss dispenser 30 has an interior space 31 for accommodating the dental floss stick 10 and/or the dental floss 20. This space is formed by the housing base body 32 and the cover device 33. The housing base body 32 has a base unit from which a wall 61 protrudes fully circumferentially and transversely thereto. In this manner, a pot-shaped housing base body 32 is realized. The interior space 31 is closed by the cover device 33, which comprises a cover unit and likewise a wall 61 protruding fully circumferentially and transversely thereto. The walls 61 of the housing base body 32 and the cover device 33 are aligned flush in the closed—i.e., connected—state. For a flush connection between the cover device 33 and the housing base body 32, the wall 61 of the housing base body 32 has a shoulder 62, such that a portion of the wall 61 extending from the shoulder 62 has a smaller dimension—in this case a smaller outer diameter—compared to the remaining wall 61 in the direction of the cooperating contact surface with the complementary wall 61. In this manner, the complementary wall 61 of the cover device 33 can be placed onto the recessed wall 61 of the housing base body 32 and abuts against the shoulder 62. The remaining, non-recessed wall 61 of the housing base body 32 has essentially the same outer dimension as the complementary wall 61 of the cover device 33. The recessed wall 61 of the housing base body 32 has essentially the same outer dimension as the inner dimension of the complementary wall 61 of the cover device 33. In a plan view, the cross-section of the dental floss dispenser 30 is shaped somewhat like a figure-eight or a keyhole. The dental floss dispenser 30 is thus configured as a type of pistol grip having two different sections for ergonomic gripping (see FIGS. 5 and 9). The pistol grip is to be understood such that it forms a grip for the elongated dental floss stick 10 oriented transversely (FIG. 5) or longitudinally (FIG. 9) relative to its main extension direction L. Similar to a pistol, the handle protrudes from the main extension direction L and enables a corresponding grip by a user. The handle protrudes such that the dental floss stick 10 projects transversely (FIG. 5) or longitudinally (FIG. 9) relative to an extension of the arm, or as an extension of the arm of a gripping user, for example along the main extension direction L. The dental floss dispenser 30, configured in the manner of a pistol grip, has two different sections or areas 38 and 39 for ergonomic gripping. The dental floss dispenser 30 thus comprises approximately two merging, partially overlapping hollow cylinders with circular or oblong cross-sections. The diameters of the respective hollow cylinders are preferably different, in particular the respective outer diameters.

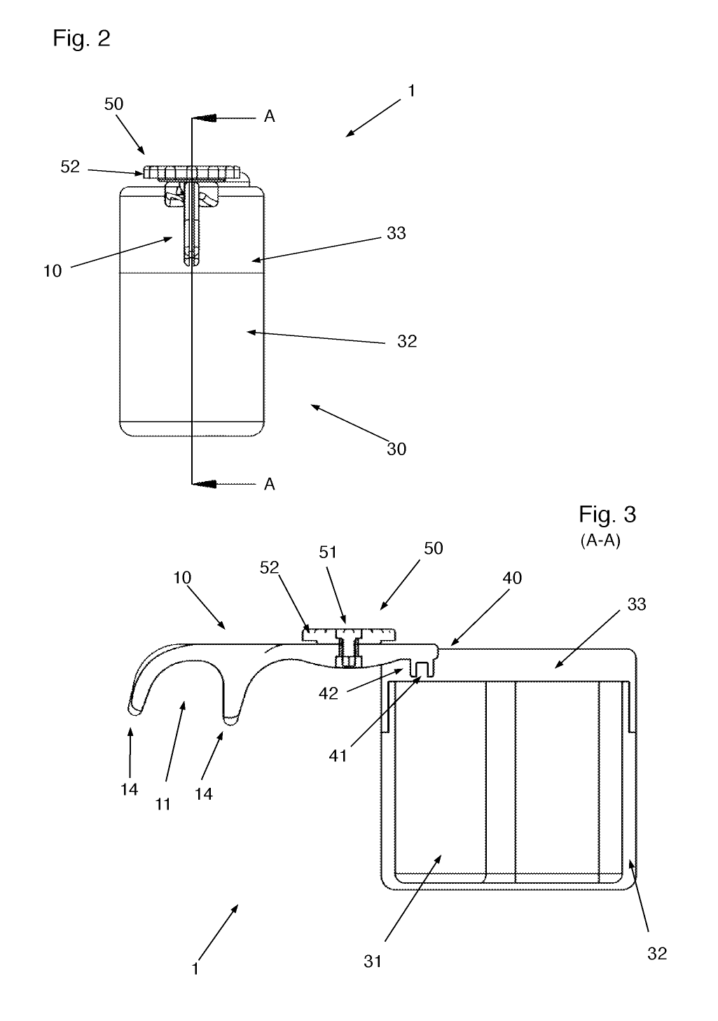

FIG. 2 shows a front view of an embodiment of the dental floss device 1 in the assembled state. In the front view, the flush joint of the cover device 33 and the housing base body 32 can be seen. The dental floss stick 10 protrudes approximately centrally from the cover device 33. The handle 52 of the clamping device 50 is arranged on the dental floss stick 10. The dental floss dispenser 30 protrudes from an opposite side of the dental floss stick 10 relative to the handle 52.

FIG. 3 shows the section A-A of the embodiment according to FIG. 2. The second connecting member 42 is configured here as an annular protrusion. The first connecting member 41 is configured to be complementary thereto with an annular recess.

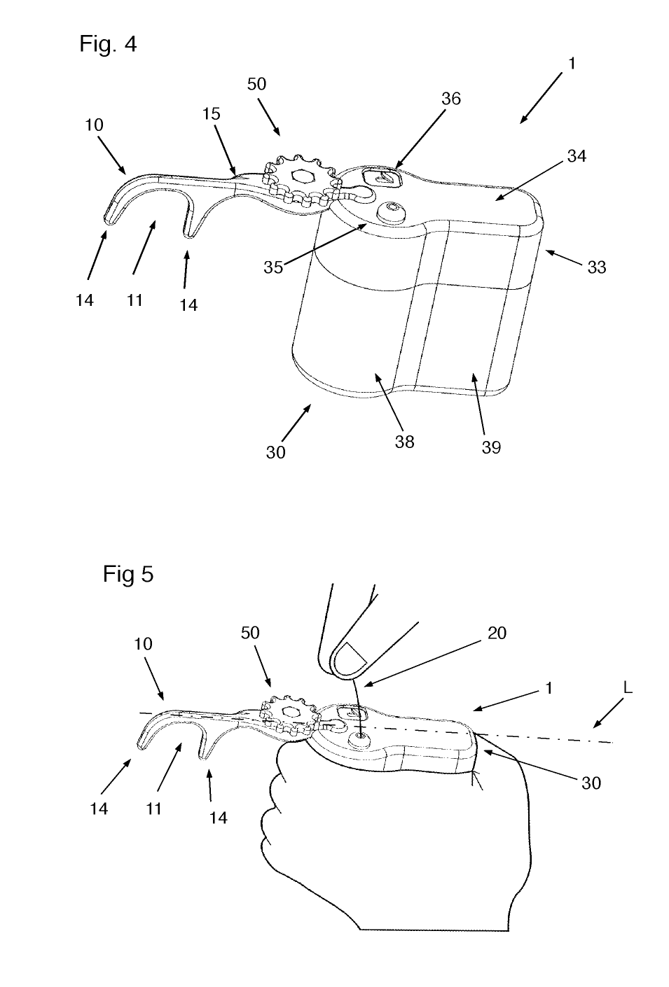

FIG. 4 shows a perspective view of the embodiment according to FIG. 3. The cutting unit 36 is configured as a sharp-edged, bent sheet metal part. This part is arranged in a corresponding receiving opening on the outer side 34 of the cover device 33. The dental floss stick 10 has the guide groove 15 adjacent to the clamping device 50.

FIG. 5 shows the start of a stringing process. After the dental floss stick 10 is mounted on the dental floss dispenser 30, the dental floss 20 is pulled out through the through-opening 35. The dental floss 20 is then guided around the clamping device 50 and routed along the groove 15 circumferentially around the dental floss stick 10, over the arms 14 thereof, and again around the clamping device 50.

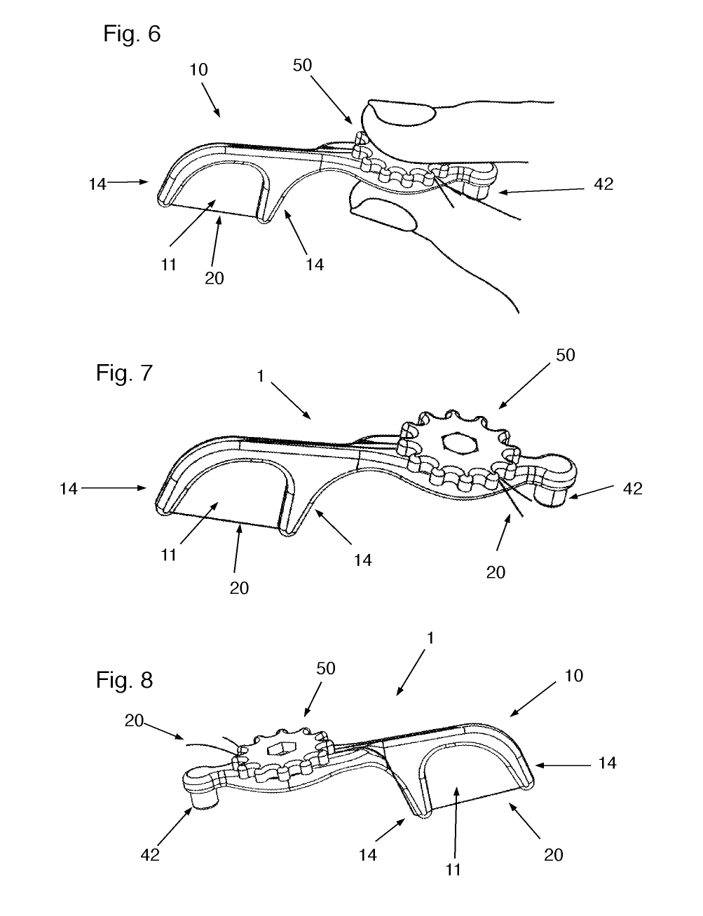

FIG. 6 shows the strung dental floss stick 10 in a state of use. The dental floss stick 10 is detached from the dental floss dispenser 30. The dental floss 20 is clamped and/or tensioned on the dental floss stick 10 by means of the clamping device 50. The dental floss 20 of the dental floss stick 10 is severed from the remainder of the dental floss 20 remaining at the dental floss dispenser 30 by means of the cutting unit 36. Due to being guided over the two arms 14, the dental floss 20 spans the recess 11. This state is also shown in FIG. 7 (without the fingers of a user for a better overview).

FIG. 8 shows the strung state according to FIGS. 6 and 7 in a different perspective view. The dental floss 20 is clamped with both of its ends on the same side of the clamping device 50.

Similarly to FIG. 5, FIG. 9 shows the start of a stringing process, however, with a different grip position. In FIG. 5, the user holds the handle transversely to its main extension direction L. In FIG. 9, the user holds the handle longitudinally to its main extension direction L. After the dental floss stick 10 is mounted on the dental floss dispenser 30, the dental floss 20 is pulled out through the through-opening 35. The dental floss 20 is then guided around the clamping device 50 and routed along the groove 15 circumferentially around the dental floss stick 10, over the arms 14 thereof, and again around the clamping device 50.

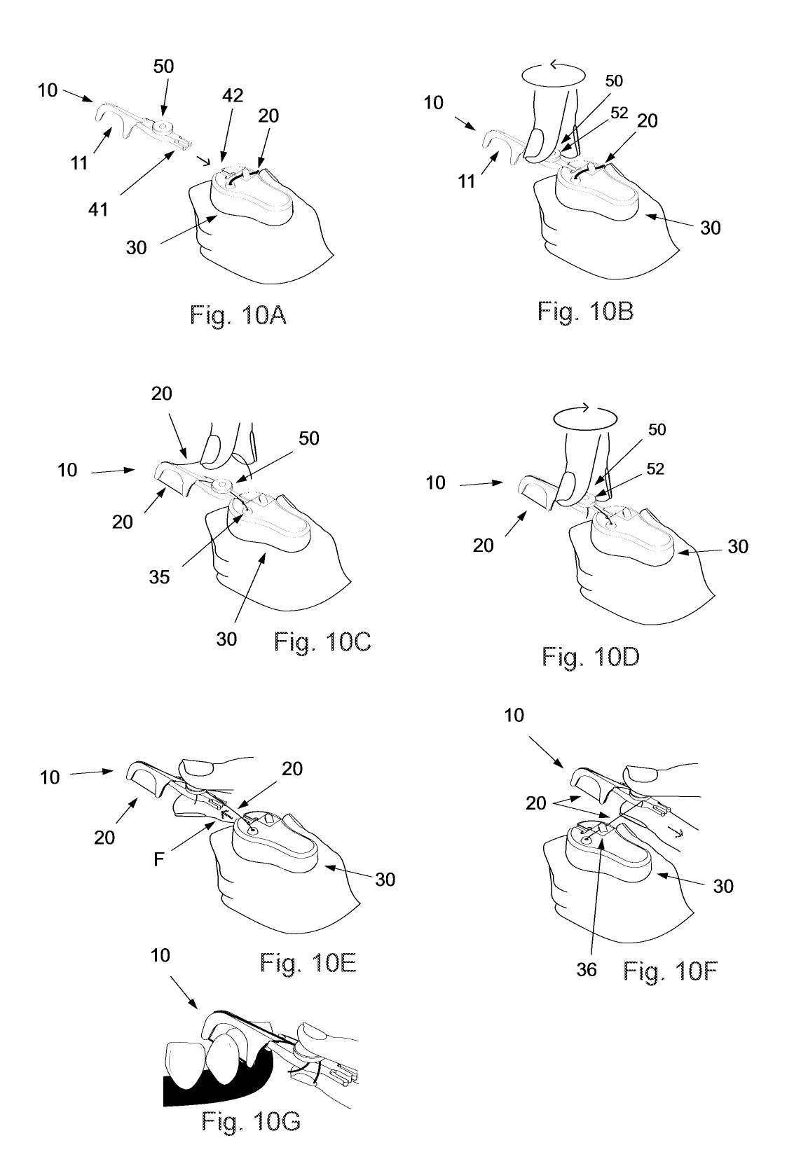

FIGS. 10A-10G schematically show a process for assembling a dental floss stick 10 and cleaning interdental spaces with another embodiment of a dental floss device 1 in several perspective partial views. In the first partial view, the separate dental floss stick 10 is moved with the second connecting members 42 leading toward the first connecting members 41 of the dental floss dispenser 30. The dental floss dispenser 30 is held with one hand by a user. In the second partial view, the dental floss stick 10 is connected to the dental floss dispenser 30 by bringing the connecting members 41 and 42 into engagement with each other. In the first two partial views, the dental floss stick 10 is unstrung, i.e., not surrounded by dental floss. While the user holds the dental floss dispenser 30 with one hand, the user actuates the clamping device 50 with the other hand. In the illustrated embodiment, the user rotates a handle 52 of the clamping device 50 to create a gap between the clamping device 50 and the dental floss stick 10. The dental floss stick (10) is connected to the dental floss dispenser (30) via the connecting members (41, 42) in the partial view. In the third partial view, the dental floss 20 is guided around the dental floss stick 10 and the dental floss stick 10 is strung. Here, the user guides the dental floss 20 around the dental floss stick 10 across the recess 11 and, with one end and a portion protruding from the dental floss dispenser 30, through the gap formed between the clamping device 50 and the dental floss stick 10. In the fourth partial view, the clamping device 50 is then actuated by the second hand of the user, thereby clamping and tensioning the dental floss 20. After clamping and/or tensioning the dental floss 20, the dental floss stick 10 is separated from the dental floss dispenser 30, as shown in the next partial view. During this, a portion of the dental floss 20 stored in the dental floss dispenser 30 is pulled out of the dental floss dispenser 30. In a next step, as shown in the following partial view, the dental floss 20 located between the dental floss dispenser 30 and the dental floss stick 10 is severed from the remaining dental floss 20 predominantly located in the dental floss dispenser 30. For this purpose, the corresponding part of the dental floss 20 is brought into engagement with the cutting unit 36 and thereby severed. The strung dental floss stick 10 can now be used as a freely movable tool for cleaning interdental spaces, as shown in the last partial view.

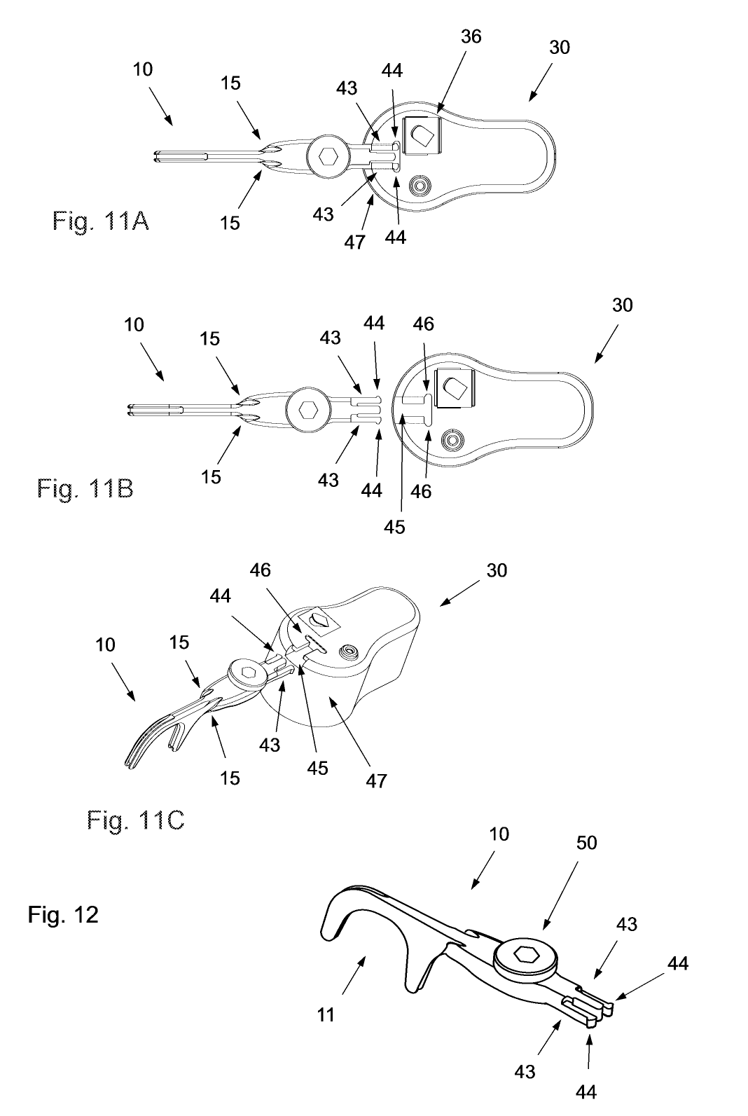

FIGS. 11A-11C schematically shows a connection or disconnection process of an embodiment of a dental floss stick 10 from an embodiment of a dental floss dispenser 30 in various views. In the first view, the dental floss stick 10 is connected to the dental floss dispenser 30 via the connecting members 41 and 42. The first connecting members are configured as two resilient protrusions 43, each having a hook 44 at its end that projects away from the respective other protrusion 43. The protrusions 43 are guided through a corresponding depression 45 in the dental floss dispenser 30. The hooks 44 at the ends engage in complementary lateral formations 46. In order to release the dental floss stick 10 from the dental floss dispenser 30, an initial force F is applied, by means of which the resilient protrusions 43 together with the hooks 44 are slightly pressed together, such that the dental floss stick 10 can be separated from the dental floss dispenser 30. This process is shown in the second partial view. The third partial view shows the dental floss stick 10 and the dental floss dispenser 30, separated and spaced apart from each other, in a perspective view. Here, the depression 45 on the top side O of the dental floss dispenser 30, which extends into the side wall 47 of the dental floss dispenser 30, is clearly visible. The depression 45 is configured to be approximately T-shaped with the formations 46 at the ends. The formations 46 form an undercut-like structure into which the hooks 44 engage when in the connected state.

FIG. 12 shows a schematic perspective view of a dental floss stick 10 detached from a dental floss dispenser 30. The two protrusions 43 and the hooks 44 at the ends thereof are clearly visible.

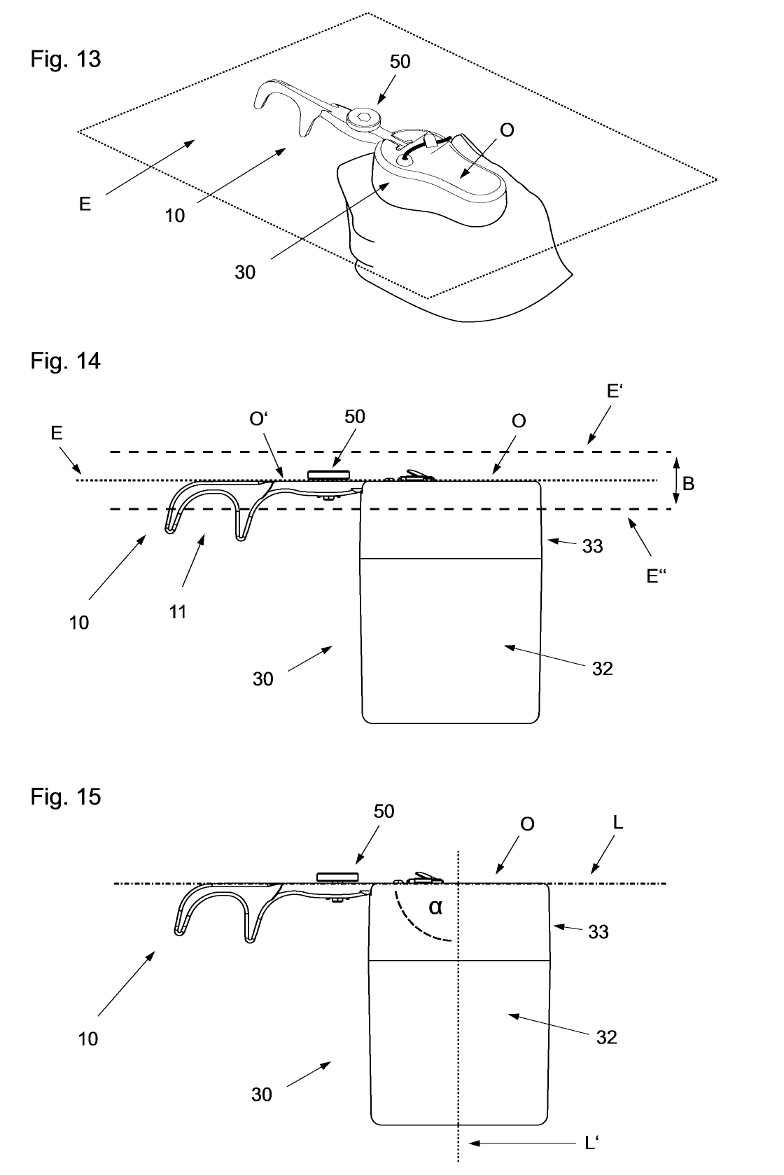

FIG. 13 shows a schematic perspective view of a plane E spanned by the top side O of the dental floss dispenser 30 while holding an embodiment of a dental floss device 1. The top side O of the dental floss dispenser 30 extends within the plane E.

FIG. 14 shows a schematic side view of an embodiment of a dental floss device 1 having a plane E spanned by the top side O, and planes E' and E'' offset parallel thereto. An upper side of the dental floss stick 10 lies flush in plane E. The clamping of the dental floss 20 occurs in this plane between the clamping device 50 and the surface O'. However, the dental floss 20 may also be clamped slightly offset from plane E in a parallel offset plane E' (or E''), i.e., in a region B between planes E' and E''. The offset of plane E relative to plane E', or the region B, is within a tolerance range which may be in a range from greater than or equal to 0 mm to less than or equal to 10 mm. The upper side of the dental floss stick 10 is arranged slightly offset from the top side O of the dental floss dispenser 30. The dental floss device 1 is thus configured such that, in the connected state, a surface O' of the dental floss stick 10 and the surface O of the dental floss dispenser 30 lie within a region B, which is bounded by the planes E'' and E' parallel to plane E, wherein plane E' is located at a maximum distance of 5 mm, preferably a maximum of 3 mm, from plane E, and plane E'' is located at a maximum distance of 5 mm, preferably a maximum of 3 mm, from plane E on the opposite side thereof.

FIG. 15 shows a schematic side view of an embodiment of a dental floss device 1 having a longitudinal axis L' extending through the housing base body 32 and the cover device 33, and a main extension direction L extending through the dental floss stick 10, which span an angle α in the side view. The angle α formed by the longitudinal axis L' and the main extension direction L is preferably greater than or equal to 70°, more preferably greater than or equal to 75°, and most preferably greater than or equal to 80°; and is preferably less than 110°, more preferably less than 100°, and most preferably less than or equal to 95°.

It is to be understood that the aforementioned features of the invention may be used not only in the specifically indicated combination, but also in other combinations or individually, without departing from the scope of the invention.

### LIST OF REFERENCE SIGNS

1 Dental floss device

10 Dental floss stick

11 Recess

12 End

13 Depression

14 Arm

15 Groove

16 Body widening

20 Dental floss

30 Dental floss dispenser

31 Interior space

32 Housing base body

33 Cover device

34 Outer side

35 Through-opening

36 Cutting unit

37 Pistol grip

38 First section

39 Second section

40 Plug-in connection

41 First connecting member

42 Second connecting member

43 Protrusion

44 Hook

45 Depression

46 Formation

47 Side wall

50 Clamping device

51 Screw

51a Screw head

51b Screw shank

52 Handle

52a Receiving opening

53 Nut

61 Wall

62 Shoulder

B Region

E Plane

E' Plane (offset)

E'' Plane (offset)

F Initial force

L Main extension direction

L' Longitudinal axis (base unit / cover unit)

α Angle between L and L'

O Surface / top side (dental floss dispenser)

O' Surface / top side (dental floss stick)

1. A method for stringing a dental floss device, in particular a dental floss stick of a dental floss device, with dental floss, comprising the steps of:
providing a dental floss dispenser filled with the dental floss,
providing the dental floss stick suitable for guiding the dental floss,
guiding the dental floss from the dental floss dispenseraround the dental floss stick,
clamping and/or tensioning the dental floss on the dental floss stickand
severing the dental floss such that the dental floss can be used with the dental floss stick separately from the dental floss dispenser,
wherein
the dental floss stick is releasably connected to the dental floss dispenser before the dental floss is guided, in particular releasably connected free of additional securing elements, in particular via a plug-in connection, and for use of the dental floss stick with the clamped dental floss, the dental floss stick is detached from the dental floss dispenser, in particular after clamping, in particular before the severing.

2. The method according to claim 1, wherein
the releasing is performed after the clamping and/or tensioning, in particular before the severing.

3. The method according to claim 1, wherein
the clamping and/or tensioning is effected via a clamping device provided on the dental floss stick, wherein the clamping deviceis released prior to the guiding and is clamped subsequent to the guiding.

4. The method according to claim 1, wherein
for the clamping and/or tensioning, the dental floss is guided toward and away from the dental floss dispenser on the same side of the clamping device and is clamped thereafter.

5. The method according to claim 1, wherein the clamping of the dental floss between the clamping device and the dental floss stick is performed on a side facing away from the dental floss dispenser, such that clamping is maintained even when the dental floss stick is moved away from the dental floss dispenser.

6. A dental floss device, in particular a dental floss device for cleaning interdental spaces, comprising:
a dental floss stick, over which a dental floss can be guided and/or is guided, wherein the dental floss spans a recess of the dental floss stick in a strung state,
a dental floss dispenser having an interior space, wherein the dental floss is storable and/or stored in the interior space and/or in which the dental floss stick is storable and/or stored, wherein
the dental floss stick is releasably connectable and/or connected to the dental floss dispenser via a plug-in connection, in particular releasably connectable free of additional securing elements.

7. The dental floss device according to claim 6, wherein the dental floss dispenser is configured with a housing base body and a cover device removable therefrom for opening and/or closing the interior space defined by the housing base body and the cover device.

8. The dental floss device according to claim 6, wherein the cover device has, on the outer side facing away from the housing base body, a first connecting memberwhich is configured to be complementary to a second connecting member of the dental floss stick provided for a releasable interaction, in particular a releasable interaction free of additional securing elements, with the first connecting member.

9. The dental floss device according to claim 6, wherein
the dental floss stick has, at its endarranged remote from the recess, the second connecting member which is configured to be complementary to the first connecting member for interaction, in particular interaction free of additional securing elements, with the first connecting member.

10. The dental floss device according to claim 6, wherein
the cover device has, on the outer side facing away from the housing base body, a through-opening and/or a cutting unit for respectively guiding dental floss out of the interior space of the dental floss dispenser and severing it from the remainder of the dental floss remaining in the interior space.

11. The dental floss device according to claim 6, wherein
the dental floss dispenser is configured in the form of a pistol grip which has two distinct sections for ergonomic gripping.

12. The dental floss device according to claim 6, wherein
a clamping device is disposed on the dental floss stick for clamping the dental floss between the clamping device and the dental floss stick on a side facing away from the dental floss dispenser.

13. The dental floss device according to claim 6, wherein
a cage and/or an encapsulation for accommodating the dental floss is provided within the interior space of the dental floss dispenser.

14. The dental floss device according to claim 6, wherein
one arm of the arms defining the recess of the dental floss stick is arranged closer to the dental floss dispenser in the assembled state than the other arm .

15. The dental floss device according to claim 6, wherein
in the connected state, a surface of the dental floss stick and the surface of the dental floss dispenser lie within a region which is bounded by planes (E') and (E'') parallel to a plane (E), wherein plane (E') is spaced apart from plane (E) by a maximum of 5 mm, preferably a maximum of 3 mm, and plane (E'') is spaced apart from plane (E) by a maximum of 5 mm, preferably a maximum of 3 mm, on the opposite side of plane (E).
